(19) United States
(12) Patent Application Publication
(10) Pub. No.: US 2017/0295495 A1
(43) Pub. Date: Oct. 12, 2017

(54) MULTIMEDIA EXCHANGE SYSTEM

(71) Applicant: Adrian Dario Arango, Miami, FL (US)

(72) Inventor: Adrian Dario Arango, Miami, FL (US)

(21) Appl. No.: 15/485,102

(22) Filed: Apr. 11, 2017

Related U.S. Application Data
(60) Provisional application No. 62/320,739, filed on Apr. 11, 2016.

(51) Int. Cl. H04W 12/08; H04W 12/06; H04L 29/06

(52) U.S. Cl. CPC H04W 12/08; H04L 63/08; H04L 63/102; H04W 12/06; H04L 63/083; H04L 63/0861

(57) ABSTRACT

A media sharing method has the steps of a user engaging with a system through profile creation and login with authentication, the system engaging one or more media platforms, authorizing the recording data, uploading the recording data to the system, uniquely identifying the recording data, and verifying and authenticating the user. It may also have the step of editing the media before uploading the recording data to the system. The media platform may comprise video, audio and text data, and the system may have the additional step of making the recording data selectively available.

### CROSS-REFERENCE TO RELATED APPLICATION(S)

The present application claims priority to U.S. Provisional Patent Application No. 62/320,739 filed on Apr. 11, 2016, entitled “MULTIMEDIA EXCHANGE SYSTEM” the entire disclosure of which is incorporated by reference herein.

### BACKGROUND OF THE INVENTION

### 1. Field of Invention

The present invention relates to the field of data exchange and storage-more specifically, to multimedia exchange, data transfer, and verification.

### 2. Description of Related Art

Information and technology transfer requires multilayer authentication and authorization as well as platforms for connection and distribution. With advances in mobile technology, people are now able to use hand-held hardware systems to capture images, record video and audio, and gather information about the user's surroundings. All of which can provide vital information to others.

The current state of the art allows for an indiscriminate type of information share where users are able to use various platforms to present information without any control post publication. Furthermore, information disclosed to specific individuals that was originally intended to remain confidential is open to subsequent publication without the originator having the ability to control the use or sharing of that information. When someone presents information into the public domain, it is extremely difficult to follow subsequent disclosure and nearly impossible to remove the information after it has been presented.

Based on the foregoing, there is a need in the art for a system whereby a user has the ability to control publication and re-publication of information he/she creates. A system is provided allowing multi-layer authorization and data tagging to permit a creator to maintain control and prevent negative reproduction of information.

### SUMMARY

A media sharing method has the steps of a user engaging with a system through profile creation and login with authentication, the system engaging one or more media platforms, authorizing the recording data, uploading the recording data to the system, uniquely identifying the recording data, and verifying and authenticating the user. It may also have the step of editing the media before uploading the recording data to the system. The media platform may comprise video, audio and text data, and the system may have the additional step of making the recording data selectively available.

Authentication of the user is performed by voice recognition, fingerprint, or password, which may be implemented by “yes” or “no” answers. The fingerprint scanner has a recording of sufficient points of similarity and difference in the fingerprint scan to determine a unique user, and the user authenticates in this manner by touching a fingerprint scanning pad to indicate “yes” or “no”. For voice recognition, a particular word may be used for certain commands, for example “yes” or “no”, and the system has recorded the voice signature of the user, accent, intonation etc. and verifies a match before authenticating. A password authentication may take place instead or in addition

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart diagram of a multimedia exchange system, according to an embodiment of the present invention.

### DETAILED DESCRIPTION OF PREFERRED EMBODIMENTS

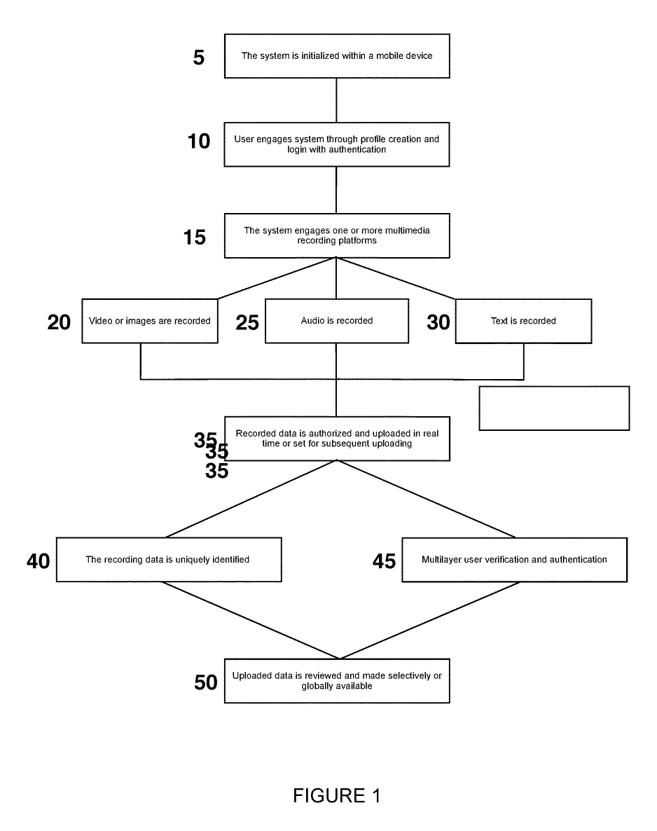

Preferred embodiments of the present invention and their advantages may be understood by referring to FIG. 1.

A multimedia exchange system is initialized within a mobile device at step 5. The multimedia exchange system has one or more access portals where a user established a profile. After a profile is created, at step 10 the user logins into the system. Once the user is authenticated to interact with their established profile, the system engages a camera, an audio recording device, and one or more sensors associated with the mobile device to capture media at step 15. The system receives information from the multiple sources and diverts the information to a storage media for review.

In an embodiment, at step 15 media such as audio (step 25) is recorded during real time conversations between users on separate mobile devices. The media may also comprise video (step 20) or text (step 30). For example, as one user places a telephone call to another the system will present options to record a single side of the conversation or both sides of the conversation. In step 35, recorded data is authorized and uploaded in real time or set for subsequent uploading. The system presents authentication algorithms for a user to verify and approve the recording. In step 40, a user inputs an authorization code into the system recognized as the user's authorization of the recording. In an alternative embodiment, the user is able to select specific contacts within the mobile device to establish pre-set authorization to expedite the approval process.

In an embodiment, as shown step, 40 an authentication code is presented in the form of an algorithm wherein the system collects data from the user, interacts with the mobile device and then presents a series of inquiries to the user specific to the user's previous use. The user responds to the inquiries through selection of images or “yes” and “no” prompts in an effort to present identification to the system. The algorithm appreciates certain thresholds of acceptable missed responses to account for mis-selection or confusion by the user. When the user has selected the inaccurate response, the system will them generate a multiplicity of fallback inquiries to ensure user authentication. For example, if a user selects an incorrect response, the system will generate two times the existing remaining inquiries to insure that the incorrect selection was merely a mis-click as opposed to an unauthorized user.

In one embodiment, at step 45 the system authenticates the user through various physical attributes incorporated into the system through the various recording devices and sensors. A mobile device having a fingerprint scanner will use this as one method of verification. Other methods include, but are not limited to, biometric identification such as facial recognition through use of the mobile device camera where a user places his/her face within a gated image frame to establish a preset likeness. Another authentication method is voice recognition where the system verifies the identity of the user through the unique tones of their voice. In another embodiment, the vocal recognition is coupled with a preset statement, phrase, or set of sounds or words that a user presents to the system through the audio recording device. In step 50 the uploaded data is reviewed and made selectively or globally available.

In an embodiment, the user has been authenticated and is presented with publication options for control over the recipients of the publication. The system allows the user to globally publish the multimedia to a social network platform whereby the user is able to control the audience for the information from the social networks friends and followers. The participants in the media (created through video, audio, or text), both sender and receiver(s), will need to give permission in order to further share with their followers/friends.

In step 15, the media is prepared, and the system engages one or more multimedia platforms, namely video, audio or text. First, it is recorded and stored within the device. Then, the media may be edited on the device and uploaded to the server or cloud. For voice recordings, such as calls, the call may be edited in step 32. In particular, the media may be condensed or shortened by selecting an abridged section of the content, condensing the media by shortening pauses or inactive periods. In the case of te, the media may be altered with notes from the altering party, wherein the altered text is set apart from the original, as blackline/strikeouts or different color or style font, for example.

The media is uploaded and stored in the cloud for sharing and transmission to other devices. The media is held in the cloud and not shared with devices until permission is provided by both parties, the preparer of the media and the intended receiver(s). If no permission is received within a predetermined time period, the media is deleted from the server and cannot be shared. Once the media is permissioned, either party may post it to their users/followers through an app at step 50. When the media is complete, one of both parties will have the option of releasing the media to their followers with a screen that will display a green “check mark” or other affirmation sign for yes or a red “X” or other negative sign for no. Authentication of the user is performed at step 45. Voice recognition, fingerprint, or password option can be used as well to give the yes or no as well. The fingerprint scanner has a recording of sufficient points of similarity and difference in the fingerprint scan to determine a unique user, and the user authenticates in this manner by touching a fingerprint scanning pad to indicate “yes” or “no”. For voice recognition, a particular word may be used for certain commands, for example “yes” or “no”, and the system has recorded the voice signature of the user, accent, intonation etc. and verifies a match before authenticating. A password authentication may take place instead or in addition, as may be appreciated in the art. Before the media is shared, the media can be edited to shorten the time/size of the media. Finally, the media can be deleted by the user whenever he/she chooses, based on a click or timed expiry, or by number of views, such as social media apps like Snapchat™ and Cyberdust™. The information is tagged with unique identifying information in step 40. For example, the user has a specific identification number in combination with a authorization number including a date stamp corresponding to when the authentication took place. The information may also include any unique identifier, possibly a password, input by the user, which the system imbeds with the multimedia information. The unique identifier becomes homogenous with the multimedia file and is subsequently searchable in the case the user desires to remove the multimedia from publication.

In one embodiment, the system stores recorded information to a storage media of the mobile device. The multimedia is still processed, generally, through the standard function of the mobile device. However, the system will divert a copy of the multimedia to a specific storage for processing and review prior to publication. The user accesses the multimedia in the storage and determines whether or not to publish the information.

In an alternative embodiment, the user is capable of streaming the media to a pre-set destination for instant publication to the user's select audience.

In an embodiment, the system records any information presented through the mobile device in step 15. When an image, video, or audio file is presented to the mobile device, the system captures the playback or presentation of the multimedia and diverts the file to the storage media. For example, a mobile device has video calling capabilities where the system is able to record the entire conversation or selected segments for later publication.

In some embodiments, the system operates within the mobile device.

In one embodiment, the system engages a Global Positioning Satellite (GPS) for geolocation of the system during recording or subsequent transfers. In another embodiment, the system imprints the geolocation of the creation of the multimedia onto the file for subsequent identification and location of the file in post-publication dissemination.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claim.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A media sharing method, comprising:
a. uploading data for recording to a system in connection with providing authenticated credentials to the system, said data having been exchanged between two or more parties; and
b. authorizing access to the data, for publication, to one or more media platforms in connection with receiving permissions from the two or more parties.

2. The media sharing method as recited in claim 1 further comprising:
editing the data before uploading the data, for recording, to the system.

3. The media sharing method of claim 1, wherein the media platform comprises video, audio and text data.

4. The media sharing method of claim 1 further comprising the step of making the recording data selectively available.

5. A computer-readable, non-transitory programmable product, for implementing the sharing of media among two or more users comprising code executable by a processor for causing a processors to do the following
a. receive upload data for recording to a system in connection with receiving authenticated credentials to the system, said data having been exchanged between two or more parties; and
b. provide authorization access to the data, for publication, to one or more media platforms in connection with receiving permissions from the two or more parties.

6. The computer-readable, non-transitory programmable product as recited in claim 5 wherein the media platform comprises video, audio and text data.

7. The computer-readable, non-transitory programmable product, as recited in claim 5, further comprising code for making the data selectively available.

8. A system for sharing media comprising:
a. storage for receipt of uploaded data to a system in connection with receipt of authenticated credentials to the system, said data having been exchanged between two or more parties;
b. means to authorization access to the data, for publication, to one or more media platforms in connection with receiving permissions from the two or more parties.

9. The system for sharing media as recited in claim 8 wherein the media platform comprises video, audio and text data.

10. The system for sharing media as recited in claim 8 further comprising means for making the data selectively available.
